(19) United States
(12) Patent Application Publication
(10) Pub. No.: US 2024/0336704 A1
(43) Pub. Date: Oct. 10, 2024

(54) METHODS FOR THERMALLY INHIBITING STARCH

(71) Applicant: CORN PRODUCTS DEVELOPMENT, INC., Westchester, IL (US)

(72) Inventors: Emily BORLAND, Bridgewater, NJ (US); Wajira RATNAYAKE, Bridgewater, NJ (US); Tarak SHAH, Bridgewater, NJ (US)

(21) Appl. No.: 18/293,553

(22) PCT Filed: Aug. 2, 2022
(86) PCT No.: PCT/US2022/039103

§ 371 Date: Jan. 30, 2024

Related U.S. Application Data
(60) Provisional application No. 63/231,099, filed on Aug. 9, 2021.

(51) Int. Cl. C08B 30/14; C08B 30/02; C08B 30/06

(52) U.S. Cl. CPC C08B 30/14; C08B 30/02; C08B 30/06

(57) ABSTRACT

The technology disclosed in this specification pertains to methods of making thermally inhibited starch and flour using microwave heating. Using microwave heating methods, thermally inhibited starch and flour can be obtained in less time and at lower temperatures than are needed to make similar inhibited starch or flour using forced air heating methods. Also disclosed are thermally inhibited starches and flours obtained from the methods and compositions using such thermally inhibited starches and flours.

The technology disclosed in this specification pertains to methods of making thermally inhibited starch and flour using microwave heating.

Starch is a known food ingredient, a substantial component of flour, and it has various uses in food. For example, starch is commonly used to thicken aqueous solutions. In part, this happens because starch is naturally in granular form. During heating in aqueous solution, the starch granules swell and, if the heating continues, the granule eventually breaks down and releases the starch polymers, amylose and amylopectin, into solution. Consequently, the solution's viscosity drops, which is undesirable in some food products and food making processes. To control against viscosity breakdown, starch can be inhibited before it is added to aqueous solutions. Here, inhibition refers to a set of processes that help the starch granule resist swelling and disintegration when heated in an aqueous solution.

One way to inhibit starch is to heat dehydrated starch in a process called thermal inhibition process. The process can be applied to starch or to flour to make thermally inhibited starch or flour. Methods of making thermally inhibited starch and flour are known and described, for example, in WO 2020-139997. Generally, the processes described in the '997 application adjust the pH of a native starch or flour in an aqueous solution. The adjusted starch or flour is dried to a moisture content of less than about 2% (wt. %) and the dried starch or flour is then further heated for enough time to obtain a desired degree of inhibition in the starch.

Obtaining a commercially meaningful degree of inhibition requires a long time, on the order of a hours when heated at a temperature between 140° C. and 170° C. This specification discloses methods for thermally inhibiting starch or flour using microwave heating. The disclosed methods are performed in shorter times and at lower temperatures compared to is other methods used to obtain similar degrees of inhibition.

### BRIEF DESCRIPTION OF THE FIGURES

FIG. 1 graphs changes in viscosity over time and temperature in waxy corn starch inhibited for various amounts of time using a forced-air oven.

FIG. 2 graphs changes in viscosity over time and temperature in waxy corn starch inhibited for various amounts of time using a microwave vacuum dryer.

FIG. 3 graphs changes in viscosity over time and temperature in waxy rice flour inhibited for various amounts of time using a microwave vacuum dryer.

The technology disclosed in this specification pertains to methods for making thermally inhibited starch or flour using microwave heating. In any embodiment described in this specification, a method for making a thermally inhibited starch or flour comprising: soaking a native starch or flour in an aqueous buffered solution; drying the starch or flour to a moisture content of less than about 2% (wt. %); and heating the dried starch or flour using microwaves at a temperate from about 110° to about 140° C.

In any embodiment for making a thermally inhibited starch or flour described in this specification, starch is heated for a time up to about 30 minutes or for about 5 to about 20 minutes, or about 10 to about 20 minutes, or from about 5 to about 15 minutes.

In any embodiment of the methods for making a thermally inhibited starch or flour described in this specification the starch or flour is dried to moisture content of less than about 2% (wt. %) and heated at the same temperature for an additional time. In any embodiment of the methods for making a thermally inhibited starch or flour described in this specification the starch or flour is dried at a temperature below 140° C. to a moisture content of less than about 2% and then is heated at the same temperature below 140° C. for an additional time. In any embodiment of the methods for making a thermally inhibited starch or flour described in this specification is dried and heated at one temperature between 110° and 140° C. for a total time of up to about 60 minutes about 35 to about 60 minutes, or about 40 to about 50 minutes, or about 35 to about 45 minutes. Within this specification reference to a being heated at one or more temperatures means that the starch is subjected to a temperature for a defined time. During the described heating steps, a starch may but does not necessarily reach an internal temperature equal to the temperature at which it is heated.

Starch may be heated in a batch process, where batches of starch are placed into a microwave reactor and heated and are removed prior to adding another batch of starch. Starch may also be heated in a continuous process for example, starch may be deposited in a substantially uniform layer onto a moving conveyor belt or similar apparatus that passes through a microwave reactor for times and at the temperature as said for the various embodiments described in this specification.

Microwave heating thermal inhibition processes can be adjusted to obtain lightly, moderately, and highly thermally inhibited starches. In any embodiment described in this specification, degree of thermal inhibition can be measured using a pasting profile evaluation which is commonly used in the industry to measure the change in viscosity of a slurry over time as the slurry is heat and cooled using a micro-visco-amylograph or similar equipment. This specification defines a preferred micro-visco-amylograph test using a slurry having 6% starch or flour solids and having pH adjusted to either pH 6 or pH 3 (defined in full below). In any embodiment described in this specification a thermally inhibited starch is inhibited so that a starch slurry at pH 6 evaluated using the micro-visco-amylograph test has a peak hot paste viscosity of less than about 1200. In some embodiments the starch is inhibited to have a hot paste peak viscosity (using the micro-visco-amylograph test at pH 6 from about 800 to about 1200 MVU (micro-visco-amylograph units). In some embodiments the starch is inhibited to have a hot paste peak viscosity (using the micro-visco-amylograph test at pH 6 from about 300 MVU to about 800 MVU. In some embodiments the starch is inhibited to have a hot paste peak viscosity (using the micro-visco-amylograph test at pH 6 less than about 300 MVU. Micro-visco-amylograph testing can be run using other weight percentages or temperature protocols.

In some embodiments described in this specification the thermal inhibition processes using microwaves heating are optimized so that when using the micro-visco-amylograph test the thermally inhibited starch or flour has no viscosity breakdown during the heating phase. Starches and flour are thermally inhibited so that they have no viscosity breakdown are commercially desirable because they provide stable viscosity under normal food processing conditions, enabling production of consistent and predictably textured food products. In some embodiments, the thermally inhibited starches obtained from the various methods described in this specification have no viscosity breakdown during the heating phase of a micro-visco-amylograph test at pH 6. In some embodiments the thermally inhibited starches obtained from the various methods described in this specification also have no viscosity breakdown during the heating phase of a micro-visco-amylograph test at pH 3.

In embodiments of the method for thermally inhibiting starch or flour described in this specification, the dried starch or flour having moisture content less than about 2% (wt. %) is heated at a temperature from about 110° C. to 120° C. for about 10 minutes to about 20 minutes. In any embodiment, the thermally inhibited starch or flour obtained using the conditions described in this paragraph has a peak hot paste viscosity of less than about 300 MVU and no viscosity breakdown measured using a micro-visco-amylograph test at pH 6. In any embodiment, the thermally inhibited starch or flour obtained using the conditions described in this paragraph has a peak hot paste viscosity of less than about 300 MVU and no viscosity breakdown measured using a micro-visco-amylograph test at pH 3.

In any method for thermally inhibiting starch or flour described in this specification, the dried starch or flour having moisture content less than about 2% (wt. %) is heated at a temperature from about 125° to about 135° C. for from about 5 to about 15 minutes. In any embodiment, the thermally inhibited starch or flour obtained using the conditions described in this paragraph wherein optimally the thermally inhibited starch or flour obtained from the method has a peak hot paste viscosity of from about 300 to about 800 MVU and no viscosity breakdown measured using a micro-visco-amylograph test at pH 6. In any embodiment, the thermally inhibited starch or flour obtained using the conditions described in this paragraph has a peak hot paste viscosity of from about 300 to about 800 MVU and no viscosity breakdown measured using a micro-visco-amylograph test at pH 3.

At a defined temperature, the time needed to obtain a desired degree of thermal inhibition can vary depending on the concentration of the buffer in the aqueous buffered solution. In any embodiment of the methods described in this specification. Any food grade buffering agent can be used to make aqueous buffered solution, including any salt of a food grade organic acid. In at least some embodiments the buffer in the buffered solution is a carbonate or a citrate buffer. Depending on the buffer system used buffered starches or flour may have pH between about 4 and 10 using any suitable food grade acid or base. In some embodiments described in this specification the starch is a buffered starch or flour is adjusted to pH from about 7 to about 10 or from about 8 to about 10. In some other embodiment described in this specification a buffered starch or flour is adjusted to pH from about 6 to about 8. In still other embodiments described in this specification a buffered starch or flour is pH adjusted to pH from about 4 to about 7 or from about 4 to about 6, or from about 4.5 to about 5.5.

Buffered starches may be further pH adjusted to pH between about 4 and 10 using any suitable food grade acid or base. In some embodiments described in this specification the starch a buffered starch or flour is adjusted to pH from about 8 to about 10. In some other embodiment described in this specification a buffered starch or flour is adjusted to pH from about 6 to about 8. In still other embodiments described in this specification a buffered starch or flour is pH adjusted to pH from about 4 to about 6, or from about 4.5 to about 5.5. Adjusting pH of a starch or flour may be done by adding acid or base to a buffered solution or recovering starch from a buffered solution and then soaking the starch or flour

The thermally inhibited starches and flour made using the methods described in this specification may be washed following thermal inhibition but do not need to be washed. In any embodiment the methods for making a thermally inhibited starch or flour described in this specification, the thermally inhibited starch or flour is washed following thermal inhibition and then dried following washing to a moisture content of about the equilibrium moisture of the native starch or flour. In any embodiment the methods for making a thermally inhibited starch or flour described in this specification, the thermally inhibited starch or flour is remoistened thermal inhibition in a single-phase process to obtain a remoistened starch having a moisture content equal to about the equilibrium moisture of the native starch or flour. In any embodiment the methods for making a thermally inhibited starch or flour described in this specification, the thermally inhibited starch or flour reaches the equilibrium moisture of native starch or flour under ambient conditions without washing and drying or remoistening. Equilibrium moisture of starch is between 10% and 15% moisture (wt. %).

Any starch containing base material may be used to make the thermally inhibited starches according to the methods described in this specification. Useful base materials for making thermally inhibited starches and flours from the method described in this specification include but are not limited to rice, tapioca, waxy rice, waxy tapioca, corn, waxy corn, potato, waxy potato, pea, chickpea, fava bean, lentil, sago, quinoa, and mixtures thereof.

This specification also discloses thermally inhibited starch or flour obtained by a process as described in any foregoing method.

A composition comprising a thermally inhibited starch or obtained by a process as described in any foregoing claim and a second ingredient. Such compositions may be edible composition, cosmetic compositions, compositions useful for household cleaning uses, or industrials uses.

With reference to compositions that are edible ingredients, second ingredients can be any edible ingredient, including but not limited to aqueous or lipid-based ingredients, fats, oils, other starches (including native, gelatinized, and modified starches), protein isolates or concentrates, flour, hydrocolloids or gelling agents, flavorings, coloring, sweeteners, and dairy ingredients. Thermally inhibited starches and flours can be used in amounts suitable for the intended end-product, but generally in an amount between about 1% and up to about 99% of the composition.

Edible compositions include baked goods, yogurts, soups, sauces, dressings, gravies, retorted foods, pet foods, gluten free baked goods, vegan or imitation dairy products, imitation or processed cheese products, puddings, confectionary compositions, beverages and non-dairy creamers.

With reference to usage, this specification refers to starch and flour separately. But for convenience, reference to thermally inhibited starch or flour means thermally inhibited starch or thermally inhibited flour. Also, reference to thermally inhibited starch and flour means thermally inhibited starch and thermally inhibited flour. The same principle applies to describe modified starch or flour, native starch or flour, and the like throughout this specification.

Reference to “starch” in this specification refers to food starch. Food starches are known and have their full meaning in the art. As rules of thumb though not intending to be strictly limiting, food starch from high amylose corn starch commonly contains less than about 1% (wt. %) protein or other contaminants (wt. %) and so is about 99% (wt. %) starch. For starches from other botanical sources, food starch commonly contains less than 0.5% (wt. %) protein or other contaminants and so is at least about 99.5% (wt. %) starch.

Reference to “high amylose corn starch” in this specification means corn kernels having a naturally high amylose content. Common dent corn has roughly 25% amylose content so corn seed having higher amylose content is considered high amylose corn starch. Common commercial variants of high amylose corn starch have about 50% or more amylose (wt. %).

Reference to “waxy starch” in this specification means low amylose starch. Depending on the botanical source the ratio of amylose to amylopectin may vary. Plant where essentially all the starch produced by the plant is amylopectin are commonly referred to as waxy plant. Commonly waxy plant varieties have less than about 5% amylose (wt. %) and more commonly essentially 0% amylose.

Reference to “flour” in this specification means a milled or otherwise ground composition obtained from a starch containing plant organ (e.g. seed or tuber) having starch content too low to be starch as defined in this specification. These plant organs may be processed before milling or grinding to remove parts of the organ. For example grains comprise starch and can also have components such as bran and endosperm, which may be retained and milled or removed before milling. In both instances the milled or ground composition is a flour. Methods of milling and grinding are known in the industry and flour is not limited by the type of milling or grinding used to make the flour. Additionally, commonly, though not necessarily, flour is defined by its protein content and different flours may be made to have different protein content. For example a flour may have protein content roughly equal to, less than, or greater than, the protein content naturally present in the plant organ from which it was derived.

Reference to “native” starch or flour in this specification means a starch or flour that is not modified, for example using physical, chemical, or enzymatic processes. Commonly, native starch and native flour can be identified by viewing the starch (or starch within the flour) under polarized light microscopy, where a native starch exhibits a Maltese cross-like diffraction pattern.

Thermally inhibited starch are starches made by the process described in this specification and can be made to have different degrees of inhibition. How much a starch is inhibited can be evaluated using a micro-visco-amylograph test as defined below. For example, within this specification, starch or flour is referred to as lightly, moderately, and highly inhibited. In practice, thermally inhibited starches or flours are chosen for a food application based on the processing conditions used to make the food application. More specifically, an inhibited starch is chosen so it will most likely provide a constant viscosity or a desired viscosity profile (e.g. delayed viscosity build) through the process of making a food product. For example, an increased degree of inhibition may be used to provide stable viscosity without viscosity break down in harsher food processing conditions.

Within this specification, “lightly”, “moderately”, and “highly” inhibited thermally starch or flour are described using micro-visco-amylograph test at pH 6 according to the highest viscosity during the heating phase (“peak hot paste viscosity”). Although not necessary to meet the definition of thermally inhibited, in preferred embodiments, a thermally inhibited starch or flour has no viscosity breakdown during the heating phase of the micro-visco-amylograph. Also, with reference to various preferred embodiments a slurry can be considered to have “no viscosity breakdown” when the viscosity remains steady at a peak viscosity or when the viscosity increases while the slurry is held at 95° C. for 15 minutes. Within this context, as used in this specification, “lightly thermally inhibited starch or flour” has a peak hot paste viscosity of greater than 800 to 1200 MVU. “Moderately thermally inhibited starch or flour” has a peak hot paste viscosity between 300 and 800 MVU. “Highly thermally inhibited starch or flour” has a peak hot paste viscosity less than 300 MVU.”

Thermally inhibited starches and flours described in this specification may be pregelatinized prior to or after applying the methods for thermally inhibiting starch described in this specification using known methods, including drum drying or spray cooking. “Pregelatinization” are known term in art, are have their full meaning in this specification. Without limiting the full scope of the definition, pregelatinization refers to cooking a starch in a slurry and recovering the starch to obtain a cooked (pre-cooked relative to use in food processing) starch. Pregelatinized starches are used to provide viscosity to an aqueous solution without further cooking. Commonly, other than gelatinization, thermally inhibited starches are not further modified, but further chemical or enzymatic modifications can be used. Unless specifically described as thermally inhibited and further modified, use of thermally inhibited starches and flours in this specification refers to thermally inhibited starches and flours that are not further chemically or enzymatically modified. It is to be understood, however, that in a least at some embodiments the thermal inhibition processes described in this specification may further comprise pregelatinizing a thermally inhibited starch or thermally inhibiting a pregelatinized starch.

Reference to “microwave” or “microwaves” in this specification, depending on context, refers to both electromagnetic (“EM”) radiation and to reactors, such as microwave ovens, suitable for heating starch or flour using emission of EM radiation in at least a subset of frequencies useful for heating starch or flour. The term microwave is not strictly limited to any engineering definition of microwaves and includes frequencies that might be considered part of the radio frequency range. Industrial scale and commercial scale ovens and reactors are known and useful for heating starch or flour and can be used as described in this specification to make thermally inhibited starch or thermally inhibited flour. Such devices commonly emit EM radiation having frequency of about 915 MHz or about 2.45 GHz. Certain useful microwave ovens include functions allowing the starch or flour to be thermally inhibited at air pressure that is higher or lower than ambient air pressure.

Reference to a “micro-visco-amylograph test” within this specification means the following test. Obtain aqueous slurry of starch or flour by mixing 6% (wt. %) starch or flour with aqueous solution that was buffered, and pH adjusted to pH 6 or pH 3. Heat and stir the slurry using Brabender micro-visco-amylograph machine at a rate of 8° C. per minute from a temperature of about 50° C. to about 95° C. and hold the slurry at 95° C. for 15 minutes. Combine the heating from 50° to 95° and holding at 95° are referred to in this specification as the “heating phase” of the micro-visco-amylograph test. A useful attribute of the slurry for determining degree of inhibition is the peak hot paste viscosity, which is the highest viscosity obtained during the heating phase of the test. The micro-visco-amylograph test may end once the heating phase is complete. Although not necessary for this definition, a micro-visco-amylograph test may continue after completing the heating phase of the test. Generally, during this phase the slurry cools under ambient or controlled conditions until the slurry approaches ambient temperate and a final steady state viscosity (or gelled composition), called in this specification “cooling phase.” The cooling phase may run for any desired amount of time but is usually completed within about 30 minutes after heating is stopped, which is about one-hour total from the test's beginning.

Reference to a “single phase process” within this specification means a process that adds moisture (aqueous solution) to starch or flour in an amount where all of the solution is absorbed by the starch or flour such that there exists within the mixture only a solid phase, although the solid phase may appear wet and may be present as a cake or clump of material. A single-phase process is distinguished from a process that adds an excess of moisture creating a slurry where there exists distinct solid and liquid phases.

Use of “about” to modify a number is meant to include the number recited plus or minus 10%. Where legally permissible recitation of a value in a claim means about the value. Use of about in a claim or in the specification is not intended to limit the full scope of covered equivalents.

Recitation of the indefinite article “a” or the definite article “the” is meant to mean one or more unless the context clearly dictates otherwise.

While certain embodiments have been illustrated and described, a person with ordinary skill in the art, after reading the foregoing specification, can effect changes, substitutions of equivalents and other types of alterations to the methods, and of the present technology. Each aspect and embodiment described above can also have included or incorporated therewith such variations or aspects as disclosed regarding any or all the other aspects and embodiments.

The present technology is also not to be limited in terms of the aspects described herein, which are intended as single illustrations of individual aspects of the present technology. Many modifications and variations of this present technology can be made without departing from its spirit and scope, as will be apparent to those skilled in the art. Functionally equivalent methods within the scope of the present technology, in addition to those enumerated herein, will be apparent to those skilled in the art from the foregoing descriptions. Such modifications and variations are intended to fall within the scope of the appended claims. It is to be understood that this present technology is not limited to methods, conjugates, reagents, compounds, compositions, labeled compounds or biological systems, which can, of course, vary. All methods described herein can be performed in any suitable order unless otherwise indicated herein or otherwise clearly contradicted by context. It is also to be understood that the terminology used herein is for the purpose of describing aspects only and is not intended to be limiting. Thus, it is intended that the specification be considered as exemplary only with the breadth, scope and spirit of the present technology indicated only by the appended claims, definitions therein and any equivalents thereof. No language in the specification should be construed as indicating any non-claimed element as essential.

The embodiments illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group. Each of the narrower species and subgeneric groupings falling within the generic disclosure also form part of the technology. This includes the generic description of the technology with a proviso or negative limitation removing any subject matter from the genus, regardless of whether the excised material is specifically recited herein.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member, and each separate value is incorporated into the specification as if it were individually recited herein.

The technology disclosed in this specification may be better understood with reference to the following aspects that are provided for illustrative purposes and is not intended to limit the full scope of the claims.

A method for making a thermally inhibited starch or flour comprising: a. soaking a starch or a flour in an aqueous buffered solution; b. drying the starch or the flour to a moisture content of less than about 2% (wt. %); and c. heating dried starch or flour using microwaves at temperature for enough time for the starch to reach a temperature between 110° C. to 140° C.

The method of claim 1 wherein the thermally inhibited starch or flour has no viscosity breakdown measured using a micro-visco-amylograph test at pH 6.

The method of claim 1 or 2 wherein the thermally inhibited starch or flour has no viscosity breakdown measured using a micro-visco-amylograph test at pH 3.

The method of any one of claims 1 to 3 wherein the dried starch or flour is heated for a time up to about 30 minutes, or for about 5 to about 20, or for about 10 to about 20, or for about 5 to about 15 minutes.

The method of any one of claims 1 to 4 wherein the buffer in the buffered solution is a carbonate or a citrate buffer.

The method of any one of claims 1 to 5 wherein following soaking in step a) the starch or flour has a pH between about 4 and about 10.

The method of any one of claims 1 to 6 further comprising recovering the starch or flour from the aqueous buffered solution and soaking the starch in an acidic or basic solution.

The method of any one of claims 1 to 7 wherein prior to drying in step b) the starch or flour has been adjusted to a pH in a range selected from the group consisting of: a. from about 7 to about 10 or from about 8 to about 10; b. from about 6 to about 8; and c. from about 4 to about 7 or from about 4 to about 6, or from about 4.5 to about 5.5.

The method of any one of claims 1 to 8 wherein the starch or flour is dried at a temperature less than 140° C.

The method of any one of claims 1 to 9 wherein the starch or flour is dried to a moisture content of less than about 2% (wt. %) in step b) and is heated in step c) at the same temperature as in step b); wherein, optionally the temperature is less than 140° C.

The method of any one of claims 1 to 10 wherein the starch or flour is dried and heated as described in steps b) and c) at a constant temperature between about 110° C. and about 140° C. for a total time of up to about 60 minutes or from about 35 to about 60 minutes, or from about 40 to about 50 minutes, or from about 35 to about 45 minutes.

The method of any one of claims 1 to 11 wherein when measured using a micro-visco-amylograph test at pH 6 of less, the thermally inhibited starch or flour obtained from the method has a peak hot paste viscosity than about 1200 or less.

The method of any one of claims 1 to 12 wherein when measured using a micro-visco-amylograph test at pH 6, the thermally inhibited starch or flour obtained from the method has a peak hot paste viscosity in a range selected from the group consisting of: a. from about 800 to about 1200 MVU; b. from about 300 MVU to about 800 MVU; and c. less than about 300 MVU.

The method of any one of claims 1 to 13 wherein the thermally inhibited starch or flour has no viscosity breakdown during the heating phase of a micro-visco-amylograph test at pH 6.

The method of any one of claims 1 to 14 wherein the starch or flour obtained from the method has no viscosity breakdown during the heating phase of a micro-visco-amylograph test at pH 3.

The method of any one of claims 1 to 15 wherein in step c) the starch or flour is heated at a temperature from about 110° C. to about 120° C.; wherein, optionally, the starch or flour obtained from the method has a peak hot paste viscosity of less than about 300 MVU and no viscosity breakdown measured using a micro-visco-amylograph test at pH 6; and wherein, optionally, the starch or flour obtained from the method has a peak hot paste viscosity of less than about 300 MVU and no viscosity breakdown measured using a micro-visco-amylograph test at pH 3.

The method of any one of claims 1 to 16 wherein in step c) the starch or flour is heated at a temperature from about 125° C. to about 135° C.; wherein optionally the thermally inhibited starch or flour obtained from the method has a peak hot paste viscosity of from about 300 to about 800 MVU and no viscosity break down measured using a micro-visco-amylograph test at pH 6; and wherein optionally the thermally inhibited starch or flour obtained from the method has a peak hot paste viscosity of from about 300 to about 800 MVU and no viscosity break down measured using a micro-visco-amylograph test at pH 3.

The method of any one of claims 1 to 17 wherein the thermally inhibited starch or flour is washed following step c) and then dried following washing to a moisture content of about the equilibrium moisture of the native starch or flour.

The method of any one of claims 1 to 18 wherein the thermally inhibited starch or flour is remoistened following step c) in a single-phase process to obtain a remoistened starch having a moisture content equal to about the equilibrium moisture of the native starch or flour.

The method of any one of claims 1 to 19 wherein the thermally inhibited starch or flour following step c) is allowed to reach the equilibrium moisture of native starch or flour under ambient conditions without washing and drying or remoistening.

The method of any one of claims 1 to 20 wherein the native starch or flour is a flour selected from the group consisting of rice flour, tapioca flour, waxy rice flour, waxy tapioca flour, and mixtures thereof.

The method of any one of claims 1 to 21 wherein the native starch or flour is a starch selected from the group consisting of corn starch, waxy corn starch, rice starch, waxy rice starch, tapioca starch, waxy tapioca starch, potato starch, waxy potato starch, and mixtures thereof.

The method of any one of claims 1 to 22 wherein the thermally inhibited starch is not further modified.

The method of any one of claims 1 to 23 further comprising pregelatinizing, not otherwise but is not otherwise modifying, the thermally inhibited starch.

The method of anyone of claims 1 to 24 wherein in step a) the starch or flour is a pregelatinized starch or flour.

The method of any one of claims 1 to 25 wherein step a) the starch or flour is a native starch or flour.

A thermally inhibited starch or flour obtained by a process as described in any foregoing method.

A composition comprising a thermally inhibited starch or flour obtained by a process as described in any foregoing claim and a second ingredient.

The technology disclosed in this specification may be better understood with reference to the following example that is provided for illustrative purposes and is not intended to limit the full scope of the claims.

### Example—Comparing the Viscosity Profile of Air Heated and Microwave Heated Starch

This example illustrates how degree of inhibition changes when using microwave to heat starch or flour compared to heating starch with a forced-air oven. Both waxy corn starch and waxy rice flour were used as base materials in this example. Samples were prepared as follows. Base materials were soaked for at least 10 minutes in enough aqueous solution comprising tripotassium citrate to form a starch slurry. Starches were recovered from the slurries, dried in air (or under vacuum), and then thermally inhibited at a temperature of either 115° C. or 132° C. for one of 10, 15, 120, or 360 minutes. Samples were made as reported in Table 1. Note that Sample 5 and 8 were made from native versions of the base materials.

TABLE 1
Thermal Inhibition Process Conditions

| Sample No. | Base Material | Oven Type | Temp. (° C.) | Time (min.) |
|---|---|---|---|---|
| 1 | Waxy corn | Forced air | 132 | 10 |
| | starch | | | |
| 2 | Waxy corn | Forced air | 132 | 15 |
| | starch | | | |
| 3 | Waxy corn | Forced air | 132 | 120 |
| | starch | | | |
| 4 | Waxy corn | Forced air | 132 | 360 |
| | starch | | | |
| 5 | Waxy corn | None | None | None |
| | starch | | | |
| 6 | Waxy corn | Microwave | 115 | 15 |
| | starch | vacuum-dryer | | |
| 7 | Waxy corn | Microwave | 132 | 10 |
| | starch | vacuum-dryer | | |
| 8 | Waxy rice | None | None | None |
| | flour | | | |
| 9 | Waxy rice | Microwave | 115 | 10 |
| | flour | vacuum-dryer | | |
| 10 | Waxy rice | Microwave | 132 | 10 |
| | flour | Vacuum-dryer | | |

For samples made by forced air treatment, 70 grams of the buffered base material was weighed out into aluminum pans and flattened into a loosely packed thin film. The samples were placed in a forced-air oven (Thermal Product Solutions Blue M, Model DC-296-F-F4) and heated at 132° C. for 30 minutes to dry to a moisture content of less than about 2%, and the temperature was then adjusted to the desired inhibition temperature and held at that temperature for the time specified in Table 1. For samples made by microwave treatment, about 4.5 kg of the buffered base materials was placed in the microwave reactor or a microwave vacuum dryer (Marion WAVEMIX mini). The microwave device was set to obtain a desired temperature and materials were held at the desired temperature for the temperatures and times specified in Table 1. For both forced air and microwave heated samples, when the heating time was complete, the samples were removed from the oven and stored in jars under ambient conditions.

The degree of inhibition obtained in each of the samples was evaluated using the micro-visco-amylograph tests at pH 6. Namely, aqueous slurries of starch or flour were obtained by mixing 6% (wt. %) starch or flour with an aqueous solution adjusted to pH 6. The slurries were heated using a Brabender micro-visco-amylograph machine at a rate of 8° C. per minute from a temperature of about 50° C. to about 95° C. The slurries were held at 95° C. for 15 minutes. The peak hot paste viscosity of each sample was measured.

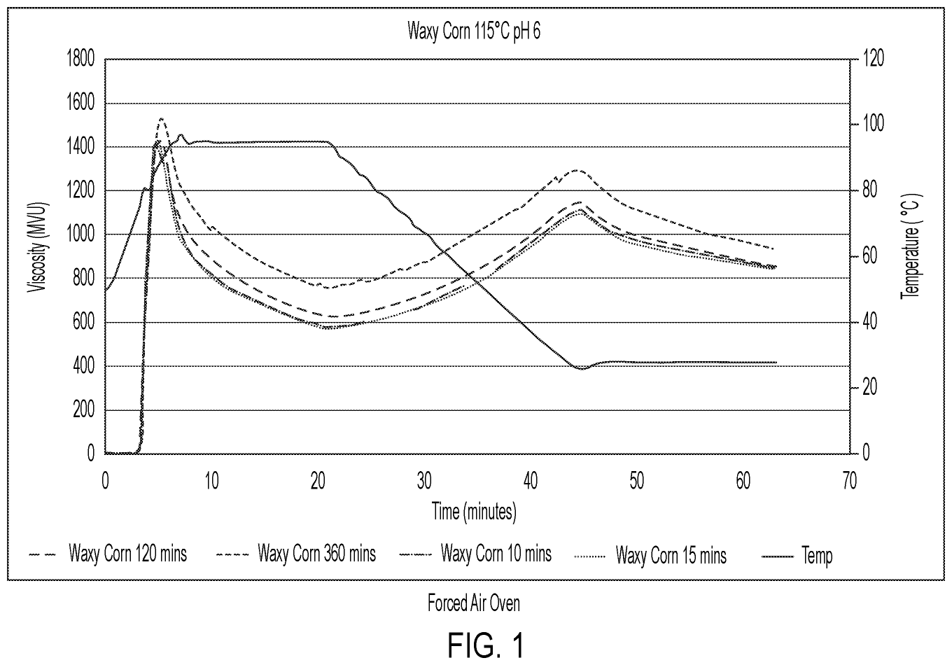

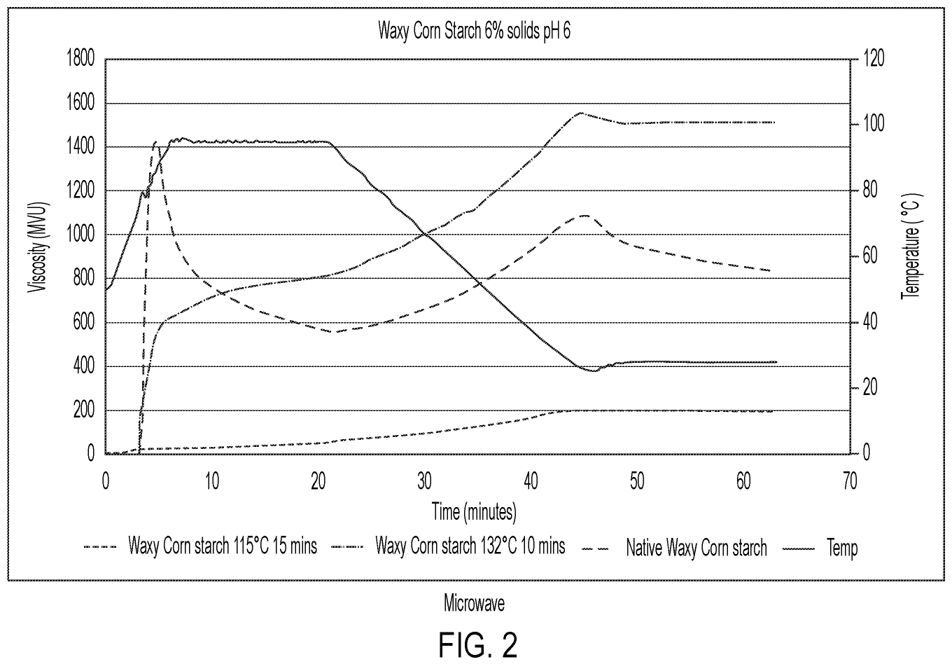

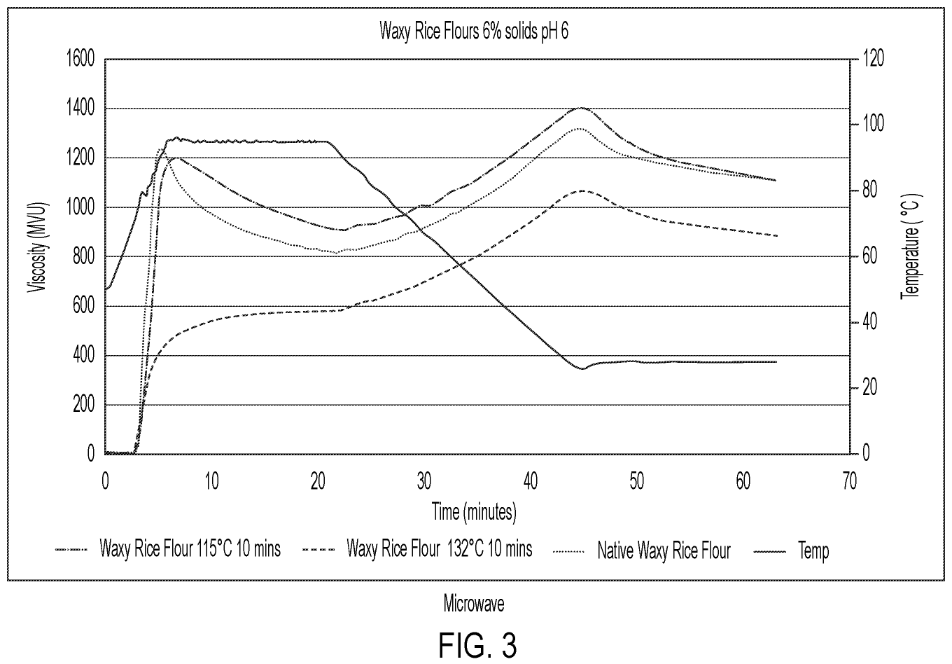

FIGS. 1 through 3 are graphs plotting the change in viscosity over time and varying temperature for starches made by the processes described above. The plots, generally, are read as follows. Viscosity is plotted on the left vertical axis. Temperature is plotted on the right vertical axis. Time is plotted on the horizontal access. FIG. 1 graphs the viscosity curves of slurries made as described for Samples 1 to 4. FIG. 2 graphs the viscosity curves of slurries made as described for Samples 5 to 7, and FIG. 3 graphs the curves of slurries made as described for Samples 8 to 10. (Each curve is for an individual sample)

Reference is first made to the viscosity curve for the slurries comprising Samples 5 and 8. Respectively, as said, these samples were made of native waxy corn starch and native waxy rice flour. As seen, both curves reached peak viscosity before the temperature reached 95° C. Viscosity then decreased immediately showing that these samples were not inhibited against viscosity breakdown. Referring to Sample 9, its graph is like Sample 8's. Also, each of Samples 1 to 4, graphed in FIG. 1, showed large viscosity breakdown soon after reaching peak viscosity. Note that the curves in FIG. 1 for waxy corn 10 minutes and waxy corn 15 minutes are present, but essentially completely overlap showing that in forced air heating essentially no difference in degree of thermal inhibition is observable with a change in heating time of five minutes. More generally, note that like native starch samples 5 and 8 and shows, each of Sample 1 to 4 have significant viscosity break down and so even for the longest heating times, at the temperatures, used, the starches are at best poorly inhibited.

In contrast, to samples 1 to 5, 8, and 9, Samples 6, 7, and 10 each obtained a peak hot paste viscosity below the peak viscosity of the corresponding native starch or flour, showing the starches were inhibited against swelling. Also, each of Samples 6, 7, and 10 showed no viscosity breakdown during the micro-visco-amylograph test, either having steady viscosity as the slurry was held at 95° C. or having a rising viscosity as the slurry was held at 95° C. This further shows again that samples 6, 7, and 10 were well inhibited as compared to native starch analogs because the thermally inhibited samples were inhibited against swelling granular (i.e. the thermally inhibited samples did not reach a viscosity as high did the native starches) and inhibited against granular disintegration (i.e. the thermally inhibited samples did not have a viscosity breakdown during heating).

1. A method for making a thermally inhibited starch or flour comprising:
a) soaking a starch or a flour in an aqueous buffered solution;
b) drying the starch or the flour to a moisture content of less than about 2% (wt. %); and
c) heating dried starch or flour using microwaves at temperature for enough time for the starch to reach a temperature between 110° C. to 140° C.

2. The method of claim 1 wherein the thermally inhibited starch or flour has no viscosity breakdown measured using a micro-visco-amylograph test at pH 6.

3. The method of claim 1 wherein the thermally inhibited starch or flour has no viscosity breakdown measured using a micro-visco-amylograph test at pH 3.

4. The method of claim 1 wherein the dried starch or flour is heated for a time up to about 30 minutes.

5. The method of claim 1 wherein the buffer in the buffered solution is a carbonate or a citrate buffer.

6. The method of claim 1 wherein following soaking in step a) the starch or flour has a pH between about 4 and about 10.

7. The method of claim 1 further comprising recovering the starch or flour from the aqueous buffered solution and soaking the starch in an acidic or basic solution.

8. The method of claim 1 wherein prior to drying in step b) the starch or flour has been adjusted to a pH in a range selected from the group consisting of:
a) from about 7 to about 10;
b) from about 6 to about 8; and
c) from about 4 to about 7.

9. (canceled)

10. (canceled)

11. The method of claim 1 wherein the starch or flour is dried and heated as described in steps b) and c) at a constant temperature between about 110° C. and about 140° C. for a total time of up to about 60 minutes.

12. (canceled)

13. (canceled)

14. (canceled)

15. (canceled)

16. The method of claim 1 wherein in step c) the starch or flour is heated at a temperature from about 110° C. to about 120° C.

17. The method of claim 1 wherein in step c) the starch or flour is heated at a temperature from about 125° C. to about 135° C.

18. The method of claim 1 wherein the thermally inhibited starch or flour is washed following step c) and then dried following washing to a moisture content of about the equilibrium moisture of the native starch or flour.

19. The method of claim 1 wherein the thermally inhibited starch or flour is remoistened following step c) in a single-phase process to obtain a remoistened starch having a moisture content equal to about the equilibrium moisture of the native starch or flour.

20. The method of claim 1 wherein the thermally inhibited starch or flour following step c) is allowed to reach the equilibrium moisture of native starch or flour under ambient conditions without washing and drying or remoistening.

21. The method of claim 1 wherein the native starch or flour is a flour selected from the group consisting of rice flour, tapioca flour, waxy rice flour, waxy tapioca flour, and mixtures thereof.

22. The method of claim 1 wherein the native starch or flour is a starch selected from the group consisting of corn starch, waxy corn starch, rice starch, waxy rice starch, tapioca starch, waxy tapioca starch, potato starch, waxy potato starch, and mixtures thereof.

23. The method of claim 1 wherein the thermally inhibited starch is not further modified.

24. The method of claim 1 further comprising pregelatinizing, but not otherwise modifying, the thermally inhibited starch.

25. The method of claim 1 wherein in step a) the starch or flour is a pregelatinized starch or flour.

26. The method of claim 1 wherein step a) the starch or flour is a native starch or flour.

27. (canceled)

28. (canceled)
